(19) United States
(12) Patent Application Publication
(10) Pub. No.: US 2004/0234719 A1
(43) Pub. Date: Nov. 25, 2004

(54) Anchoring of artificial turf

(75) Inventor: James P. Jones, Philadelphia, PA (US)

Correspondence Address: HOWSON AND HOWSON, ONE SPRING HOUSE CORPORATION CENTER, BOX 457, 321 NORRISTOWN ROAD, SPRING HOUSE, PA, 19477, US

(73) Assignee: Wayne Mills Co., Inc., Philadelphia, PA

(21) Appl. No.: 10/824,275

(22) Filed: Apr. 14, 2004

Related U.S. Application Data
(60) Provisional application No. 60/472,959, filed on May 23, 2003.

(51) Int. Cl. B32B 3/00; B29C 65/00

(52) U.S. Cl. 428/62; 156/66; 156/258; 156/304.4; 156/304.5

(57) ABSTRACT

An artificial turf playing surface utilizes hot-melt adhesive for fastening artificial turf layers to a fiber-reinforced tape, for fastening rubber particle cushion layers to a fabric tape, and for fastening the parts of mated-surface, interlocking fasteners respectively to artificial turf layers and to rubber particle cushions. The adhesive is a low-melting, polyamide adhesive, which can adhere firmly to a resin backing of a turf layer, and to a rubber-particle cushion.

### CROSS-REFERENCE TO RELATED APPLICATIONS

This application claims priority from provisional patent application 60/472,959, filed May 23, 2003.

### FIELD OF THE INVENTION

This invention relates to artificial turf, used for playing fields, and more particularly to apparatus and methods for anchoring artificial turf.

### BACKGROUND OF THE INVENTION

Artificial turf has come into widespread use on playing fields for sports such as football, soccer, lacrosse and baseball. Although initially designed primarily for indoor use, artificial turf is also used on outdoor fields. It has advantages over natural turf in that it requires less maintenance, can be repaired quickly, and can be changed over quickly to accommodate different sports.

Artificial turf is usually composed of tufts of extruded polypropylene, polyethylene, or polyamide, “grass” ribbons on a backing sheet. The backing sheet is typically a woven polyester or polyacrylonitrile textile, having a coating of polyurethane or latex for dimensional stability and for securing the tufts in place on the backing sheet. The turf is typically laid upon a resilient cushioning layer composed of rubber particles (made from used tires) in a polymer binder. In some cases the artificial turf is infilled with sand or other suitable material in order to keep the grass ribbons upright.

The artificial turf is secured in place by laying down webs of strong polyamide fabric on the resilient cushion, or on another surface, at locations where they will underlie the seams of the artificial turf, spreading a layer of glue onto the fabric webs, and then laying down the artificial turf over the layer of glue. The process of laying down artificial turf is time-consuming and labor-intensive, requiring numerous workers, carrying glue in buckets or other containers, and spreading the glue with tools such as trowels. It is difficult to calculate the amount of glue required to lay down a given field of artificial turf, and therefore there is a possibility of costly shortages or excesses. The relatively long setting time of the glue slows the installation process. Moreover, the process is hazardous, as the glues used are typically flammable, and emit fumes that can present a health hazard, especially when used in an indoor environment. Another problem in the conventional installation of artificial turf is that some conventional glues used for securing artificial turf in place are affected by changes in humidity.

Indoor carpeting, especially when covering large areas, is installed in strips, which are held together by carpet seaming tape, typically a filament-reinforced, paper-backed tape, having a layer of hot-melt adhesive. The tape is laid underneath the location of a seam where two strips of carpet meet. The adhesive is melted by passing a hot iron over the tape while temporarily separating the strips of carpet as the iron is moved over the tape along the direction of the seam. The strips are returned to contact with the melted adhesive, which, when it solidifies, securely holds the strips of carpet together. The piles of both strips of carpet merge, giving the appearance of a continuous carpet.

Although the taping technique described above is widely used in laying carpets, it has not been used successfully in laying artificial turf. The urethane or latex coating, which is exposed on the back side of the artificial turf, will not adhere adequately to carpet tape.

Another problem encountered in the installation of artificial turf is in securing cushioning layers in fixed relationship to one another. Here again, spreading glue and laying down strips of high-strength fabric over the glue are tedious and time-consuming. Moreover, carpet seaming strips will not adhere properly to cushioning layers are composed of rubber particles.

Still another problem arises where mated-surface, interlocking fasteners are used to facilitate connection and disconnection of sections of artificial turf from one another, for example to convert a baseball field to a football field. Fastener parts can be glued to some materials incorporated into artificial turf, for example woven polyamide webs, but in many other cases, they need to be sewn to the turf backing material in order to achieve adequate strength.

### BRIEF SUMMARY OF THE INVENTION

An object of this invention is to provide a seaming tape which can be used successfully in the installation of artificial turf, thereby eliminating the problems associated with installation of artificial turf in the conventional manner.

The artificial turf playing surface in accordance with the invention utilizes hot-melt adhesive for fastening artificial turf layers to a fiber-reinforced tape, for fastening rubber particle cushion layers to a fabric tape, and for fastening the parts of mated-surface, interlocking fasteners respectively to artificial turf layers and to rubber particle cushions. The adhesive is preferably a low-melting, polyamide adhesive, which can adhere firmly to a resin backing of a turf layer, and to a rubber-particle cushion.

A preferred playing surface in accordance with the invention comprises at least two layers of artificial turf in edge-to-edge, coplanar, relationship with each other along a seam, each layer comprising a textile backing having a top surface and a bottom surface, a pile composed of grass-like, polymeric tufts secured to the backing and extending upward from the top surface, and a resin layer coating the bottom surface. A elongated tape comprising a backing sheet having a coating of hot-melt adhesive on its top surface, and reinforcing fibers embedded in the coating of hot-melt adhesive, extends along the seam, with a part of the tape being underneath one of the two layers of artificial turf and a part of the tape being underneath the other layer. The hot-melt adhesive bonds the reinforcing fibers to the resin layers coating the bottom surfaces of the backings of both layers of artificial turf, thereby securing the two layers of artificial turf to each other.

In some cases, the playing surface needs to have stripes, for example white stripes on a green background, as baselines, boundary lines, yard lines, etc. In this case, the stripes can be composed of narrow strips of artificial turf, for example strips four inches in width. These strips are secured to both of two spaced layers of artificial turf by a single adhesive-coated tape, which may have two separate, parallel, stripes of fiber-reinforced adhesive. In this case, the playing surface comprises at least two layers of artificial turf in coplanar relationship with each other and separated from each other by a uniform distance. A third layer of artificial turf is disposed between the two layers, the third layer having parallel side edges, and being in edge-to edge relationship with each of the two layers. Each of the three layers comprises a textile backing having a top surface and a bottom surface, a pile composed of grass-like, polymeric tufts secured to the backing and extending upward from its top surface, and a resin layer coating its bottom surface. The third layer is narrower, in the direction of the uniform distance between the first two layers, than either of the first two layers. An elongated tape underlies the third layer and extends laterally beyond the side edges of the third layer. The tape comprises a backing sheet having a top surface, a coating of hot-melt adhesive on the top surface, and reinforcing fibers embedded in the coating of hot-melt adhesive. The coating covers at least a first area of the tape underlying at least a part of the first layer and at least a part of the third layer, and also covers a second area of the tape underlying at least a part of the second layer and at least a part of the third layer. The hot-melt adhesive bonds reinforcing fibers on the tape to the resin layers coating the bottom surfaces of one of the two layers and the third layer of artificial turf, and also bonds reinforcing fibers on the tape to the resin layers coating the bottom surfaces of the other of the two layers and the third layer, so that all three layers of artificial turf are secured to one another.

In the case of a playing surface having parts removably connected by means of mated-surface interlocking fasteners, such as hook and loop fasteners, the fasteners are bonded to the parts by a hot melt adhesive. In particular, in a cushioned playing field having a cushioning layer comprising rubber particles in a binder and a layer of artificial turf comprising a textile backing having a top surface and a bottom surface, a pile composed of grass-like, polymeric tufts secured to the backing and extending upward from the top surface, and a resin layer coating the bottom surface, a two part, mated-surface, interlocking fastener may be used to connect the turf layer to the cushioning layer. The fastener comprises a first part having a top surface, and a second part having a bottom surface, a first layer of hot-melt adhesive having embedded reinforcing fibers, bonding the reinforcing fibers of the first layer to the bottom surface of the resin layer and the top surface of the first part of the fastener, and a second layer of hot-melt adhesive having embedded reinforcing fibers, bonding the reinforcing fibers of the second layer to the top surface of the cushion layer and the bottom surface of the second part of the fastener.

Hot melt adhesive may also be used to bond adjacent layers of rubber-particle cushioning material together. In this case, the playing surface preferably comprises artificial turf, a pair of cushioning layers underlying the artificial turf, each cushioning layer comprising rubber particles in a binder. Each of the cushioning layers has an upper surface, the upper surfaces being in coplanar, edge-to-edge relationship. A layer of fabric overlies portions of both cushioning layers, and a layer of hot melt adhesive bonds the layer of fabric to both of the cushioning layers.

Other objects, details and advantages of the invention will be apparent from the following detailed description when read in conjunction with the drawings.

### BRIEF DESCRIPTION OF THE DRAWINGS

FIG. 1 is a schematic cross-sectional view showing a portion of a playing surface comprising two layers of artificial turf joined in edge-to-edge relationship in accordance with the invention;

FIG. 2 is a top plan view of a length of fiber-reinforced, hot melt adhesive tape used in connecting artificial turf layers and cushion layers in accordance with the invention;

FIG. 3 is a schematic cross-sectional view showing a portion of a playing surface cushion comprising cushion panels joined in accordance with the invention;

FIG. 4 is a is a schematic cross-sectional view showing a portion of a playing surface comprising two layers of artificial turf with a narrow third layer between them, the layers being joined in edge-to-edge relationship in accordance with the invention;

FIG. 5 is an exploded schematic cross-sectional view showing a portion of a playing surface in accordance with the invention, in which a layer of artificial turf is removably joined to a cushion by a two part, mated-surface, interlocking fastener; and

FIG. 6 is a top plan view of an reinforced adhesive strip used to secure the interlocking fasteners to the artificial turf layers and cushions.

### DETAILED DESCRIPTION OF THE PREFERRED EMBODIMENTS

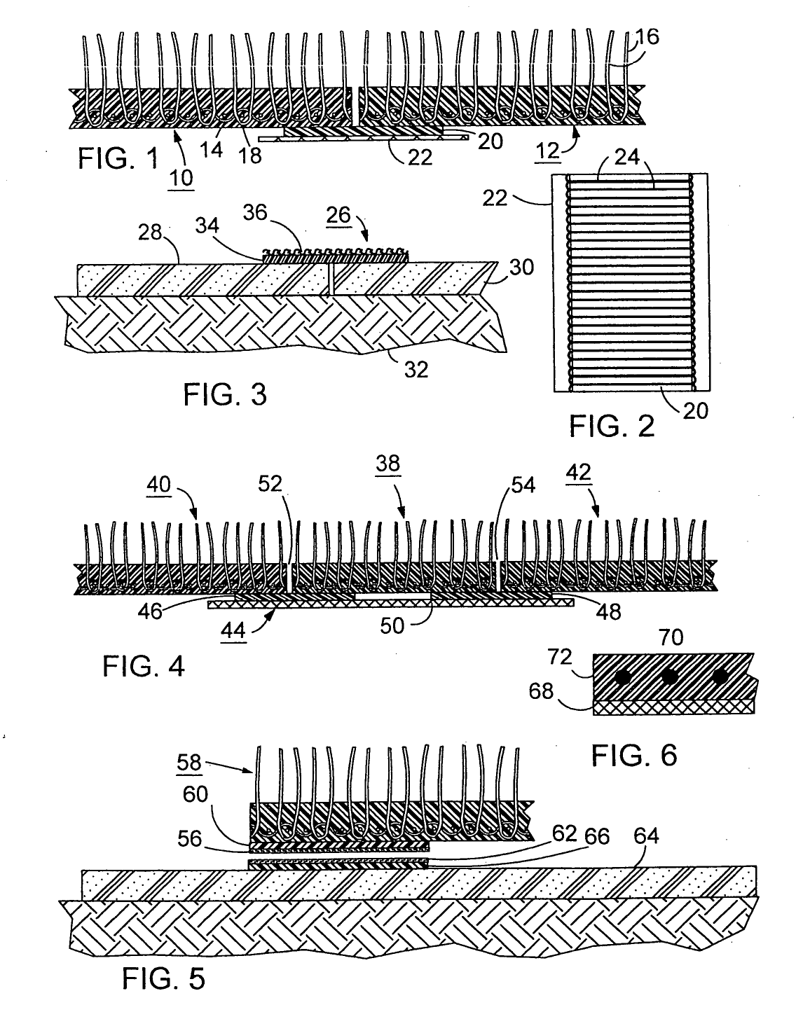

Referring to FIG. 1, each of layers 10 and 12 of artificial turf comprises a textile fabric base 14, which may be a woven or non-woven fabric, preferably composed of polyester yarns. A woven fabric base is shown in FIG. 1. Grass-like tufts 16, preferably in the form of pigmented, extruded, polypropylene ribbons, are integrated with the woven fabric base by means of tufting needles to form a grass-like pile. At least the bottom side of the fabric base is covered by an elastomeric coating 18, preferably of latex or polyurethane, to impart dimensional stability to the turf and also to secure the tufts in place. The elastomeric layer may be primarily on the underside of the fabric base, or alternatively, as shown in FIG. 1, the elastomeric layer may extend through the fabric, with a significant portion of the elastomeric layer on the top side of the fabric.

The two layers 10 and 12 of artificial turf are brought into edge-to edge relationship, and secured together by a reinforced adhesive layer supplied as a layer 20 on a paper tape 22, as shown in FIGS. 1 and 2. Reinforcing glass fiber yarns 24 are embedded in the adhesive, and extend in a coarse pattern transverse to the longitudinal direction of the tape, as shown in FIG. 2. In the preparation of the tape, the glass fiber yarns are sewn to the paper tape prior to the application of the adhesive layer.

In the installation of the artificial turf, the tape is laid on a cushion or other supporting surface, paper side down, and the two layers of artificial turf are brought into edge-to edge relationship, with their meeting edges located approximately over the center line of the tape. An electrically heated iron, of the kind used in carpet installation, is moved along, and in contact with, the adhesive layer on the tape to melt the adhesive. The edges of the artificial turf are lifted by the iron as the iron moves lengthwise along the tape. As the iron moves, causing the adhesive to melt, the edges of the turf behind the iron return into contact with the adhesive, which has been melted, and are bonded to the reinforcing fibers in the adhesive.

The paper tape 22 is preferably 50 lb. kraft paper having a width of 3.75 inches. The adhesive layer is preferably about 0.40 inch thick.

Most polyamide adhesives have a relatively high softening point, typically around 190° C. The adhesive layer used in accordance with the invention, however, is preferably a hot melt polyamide adhesive having a relatively low softening point of 150° C. or less, making it suitable for use with an iron of the kind used in carpet seaming. Polyamide hot melt adhesives are preferred because, unlike the adhesives widely used in the carpet seaming industry, polyamide adhesives are capable of adhering firmly to the polyurethane and latex layers exposed on the undersides of commercially available artificial turf materials. The polyamide adhesive available as Product 7239 from Bostik, Inc. of Middleton, Mass. has been found to be an ideal adhesive because it has a ball and ring softening point of 140° C. (284° F.), and a superior ability to adhere to polyurethane and latex.

The amount of tape needed for a given playing field is easily determined because the length of the tape is equal to the total length of the seams. There is no opportunity for the application of insufficient or excess adhesive, as is the case where brushed-on glues are used.

FIG. 3 shows a hot melt adhesive tape 26, used to secure two cushions in edge-to-edge relationship. The cushions, 28 and 30, are composed of rubber particles in a resin binder, and are typically laid upon an earth support 32. The cushions used underneath artificial turf are typically about ½ inch thick. Here, as in FIGS. 1 and 2, the adhesive layer 34 is a low-melting polyamide adhesive. The backing 36, however, is preferably a woven, texturized, polyester fabric, instead of paper, because the adhesive is melted by applying an iron to the top side of the tape, and the fabric transmits heat more readily than paper.

The tape 26 is laid, adhesive side down, on the adjoining cushions layer so that it extends longitudinally along the seam and overlies portions of both cushions. A carpet seaming iron, or other hot iron is moved longitudinally over the fabric side of the tape, causing the adhesive layer 34, underneath the fabric layer 36, to melt and adhere to the cushions. When the adhesive cools and resolidifies, the cushions are then secured firmly to the polyester weave and, through the polyester weave, to each other.

A stripe, for example a white stripe, can be laid on a playing field in the manner depicted in FIG. 4, where a narrow strip 38 of artificial turf is disposed between two wider layers 40 and 42 of artificial turf. The tufts on the strip 38 are pigmented white to contrast with the green color of the tufts on layers 40 and 42.

In laying the playing surface depicted in FIG. 4, a specially constructed tape 44, having two parallel strips 46 and 48 of reinforced adhesive on a paper layer 50, is used. The tape is laid, adhesive side up, on a cushion or other suitable supporting surface (not shown), with one of its adhesive strips extending partway under one of the wide layers of green artificial turf, and with the length of the tape parallel to the edge of the turf layer. The narrow artificial turf strip 38 is then placed in edge-to-edge relationship with the previously laid layer of artificial turf, so that its underside is engaged with the same reinforced adhesive strip which is engaged by the previously laid layer of artificial turf. Thus, as shown in FIG. 4, adhesive strip 46 is engaged with the underside of wide layer 40 and narrow layer 38. The width of the tape and the positions of the strips of adhesive thereon are such that part of the second strip of adhesive is located underneath layer 38 and another part extends outwardly beyond layer 38. A stripe is typically four inches in width, and accordingly the centerlines of the two parallel adhesive strips 46 and 48 should be four inches apart.

The next wide artificial turf layer 42 is then laid down in edge-to-edge relationship with narrow layer 38, and the layers are connected to one another by passing a hot iron along seams 52 and 54, underneath the artificial turf layers and in contact with reinforced adhesive layers 46 and 48, respectively.

The polyamide adhesive can also be used to secure parts of mated surface interlocking fasteners to the undersides of artificial turf layers and the top sides of cushion layers, as depicted in FIG. 5. The mated surface interlocking fasteners can be any of a variety of fasteners, for example the hook and loop fasteners sold under the trademark VELCRO. In this case, the same kind of adhesive material is used, but the transverse reinforcements and the paper-backing are eliminated.

As shown in FIG. 5, a first fastener element 56 is secured to the underside of an artificial turf layer 58 by an adhesive layer 60, and a second fastener element 62 is secured to the top surface of a cushion 64 by an adhesive layer 66. The adhesive layers are supplied as shown in FIG. 6, with a peelable release liner 68, preferably a silicone-coated paper, which prevents the adhesive from sticking to itself and allows the adhesive to be supplied in a roll. Longitudinal polyester fiber yarns 70 are embedded in the adhesive 72 and run longitudinally along the length of the adhesive strip. These yarns help to maintain uniformity in the adhesive layer as it is melted. The release liner 68 is removed before the adhesive is applied, and the adhesive, when applied, is essentially entirely adhesive, except for the presence of the longitudinal polyester yarns 70.

In applying the fastener element 56 to the artificial turf layer 58, the turf layer 58 is folded over to expose the portion of its underside to which the fastener element is to be applied. The adhesive strip 60 is laid on the underside of the artificial turf layer, and then heated, either by a hot iron or hot air blower, to melt the adhesive. The fastener element 56 is then set in place while the adhesive is in a melted condition. The fastener element 62 is secured to the top surface of a cushion 64 in a similar manner, by first laying the adhesive strip 66 on the cushion, heating it, and then applying the fastener element over the adhesive layer while the adhesive is in a melted condition.

The use of hot melt adhesive to secure layers of artificial turf together, to connect the underlying cushions, and to secure mated surface interlocking fasteners to the turf backing and to the cushions, is made possible by the use of low-melting polyamide adhesive. The hot melt adhesive affords significant advantages, especially in the ease and rapidity with which the artificial turf can be laid, the ease with which the necessary amount of adhesive can be determined, uniformity of adhesive application, the avoidance of noxious fumes and environmental and safety hazards, and the avoidance of detrimental effects of low and high humidity.

Various modifications can be made to the artificial turf-securing, cushion-securing, and fastener-securing tapes described above. For example, the backing for the turf-securing tapes can be woven polyester fabric instead of paper. The widths and thickness of the adhesive layers can be varied, depending on the texture of the undersides of the artificial turf layers and of the cushions.

Still other modifications may be made to the apparatus and method described above without departing from the scope of the invention as defined in the following claims.

1. A playing surface comprising:
at least two layers of artificial turf in edge-to-edge relationship with each other, and means securing said artificial turf layers to each other; and
at least two cushioning layer underlying said artificial turf layers, and means securing said cushioning layers to each other in edge-to-edge relationship;
wherein at least one of said securing means comprises a layer of hot-melt adhesive.

2. A playing surface according to claim 1, in which said layers of artificial turf have bottom sides composed of polyurethane or latex, and in which said means securing said artificial turf layers to each other is a tape comprising a layer of polyamide hot-melt adhesive having a ball and ring softening point not greater than approximately 150° C.

3. A playing surface according to claim 2, in which said tape includes glass fiber yarns embedded in said layer of adhesive.

4. A playing surface according to claim 1, in which said layers of artificial turf have bottom sides composed of polyurethane or latex, and in which said means securing said artificial turf layers to each other is a tape comprising a layer of polyamide hot-melt adhesive having a ball and ring softening point of approximately 140° C.

5. A playing surface according to claim 4, in which said tape includes glass fiber yarns embedded in said layer of adhesive.

6. A playing surface according to claim 1, in which said cushioning layers are composed of rubber particles in a binder, and in which said means securing said cushioning layers to each other in edge-to-edge relationship is a tape comprising a layer of polyamide hot-melt adhesive having a ball and ring softening point not greater than approximately 150° C.

7. A playing surface according to claim 6, in which said tape comprises a backing of woven polyester fabric.

8. A playing surface according to claim 1, in which said cushioning layers are composed of rubber particles in a binder, and in which said means securing said cushioning layers to each other in edge-to-edge relationship is a tape comprising a layer of polyamide hot-melt adhesive having a ball and ring softening point of approximately 140° C.

9. A playing surface according to claim 7, in which said tape comprises a backing of woven polyester fabric.

10. A playing surface comprising:
two layers of artificial turf in edge-to-edge, coplanar, relationship with each other along a seam, each said layer comprising a textile backing having a top surface and a bottom surface, a pile composed of grass-like, polymeric tufts secured to the backing and extending upward from said top surface, and a resin layer coating said bottom surface; and
a elongated tape comprising a backing sheet having a top surface, a coating of hot-melt adhesive on said top surface, and reinforcing fibers embedded in said coating of hot-melt adhesive;
said tape extending along said seam with a part of the tape being underneath one of said two layers and a part of the tape being underneath the other of said two layers; and
said hot-melt adhesive bonding said reinforcing fibers to the resin layers coating the bottom surfaces of the backings of both said layers of artificial turf, whereby said two layers of artificial turf are secured to each other.

11. A playing surface comprising:
two layers of artificial turf in coplanar relationship with each other and separated from each other by a uniform distance, each said layer comprising a textile backing having a top surface and a bottom surface, a pile composed of grass-like, polymeric tufts secured to the backing and extending upward from said top surface, and a resin layer coating said bottom surface;
a third layer of artificial turf disposed between said two layers, said third layer having parallel side edges, and being in edge-to edge relationship with each of said two layers, said third layer also comprising a textile backing having a top surface and a bottom surface, a pile composed of grass-like, polymeric tufts secured to the backing and extending upward from its top surface, and a resin layer coating its bottom surface, and said third layer being narrower, in the direction of said uniform distance, than either of said two layers;
a elongated tape underlying said third layer and extending laterally beyond said side edges, the tape comprising a backing sheet having a top surface, a coating of hot-melt adhesive on said top surface, and reinforcing fibers embedded in said coating of hot-melt adhesive said coating covering at least a first area of the tape underlying at least a part of the first layer and at least a part of the third layer, and also covering a second area of the tape underlying at least a part of said second layer and at least a part of the third layer;
said hot-melt adhesive bonding reinforcing fibers on said tape to the resin layers coating the bottom surfaces of one of said two layers and said third layer of artificial turf, and also bonding reinforcing fibers on said tape to the resin layers coating the bottom surfaces of the other of said two layers and said third layer artificial turf, whereby said three layers of artificial turf are secured to one another.

12. A playing surface comprising:
a cushioning layer comprising rubber particles in a binder, said cushioning layer having a top surface;
a layer of artificial turf comprising a textile backing having a top surface and a bottom surface, a pile composed of grass-like, polymeric tufts secured to the backing and extending upward from said top surface, and a resin layer coating said bottom surface; and
a two part, mated-surface, interlocking fastener comprising a first part having a top surface and a second part having a bottom surface;
a first layer of hot-melt adhesive having embedded reinforcing fibers, bonding said reinforcing fibers of the first layer to the bottom surface of said resin layer and the top surface of said first part of the fastener; and
a second layer of hot-melt adhesive having embedded reinforcing fibers, bonding said reinforcing fibers of the second layer to the top surface of said cushion layer and the bottom surface of said second part of the fastener.

13. A playing surface comprising:
artificial turf;
a pair of cushioning layers underlying said artificial turf, each cushioning layer comprising rubber particles in a binder, each of the cushioning layers having an upper surface and the upper surfaces being in coplanar, edge-to-edge relationship;
a layer of fabric overlying portions of both said cushioning layers; and
a layer of hot melt adhesive bonding said layer of fabric to both of said cushioning layers.
